(19) United States
(12) Patent Application Publication
(10) Pub. No.: US 2021/0157616 A1
(43) Pub. Date: May 27, 2021

(54) CONTEXT BASED TRANSFORMATION OF CONTENT

(71) Applicant: International Business Machines Corporation, Armonk, NY (US)

(72) Inventors: Craig M. Trim, Ventura, CA (US); Jeremy R. Fox, Georgetown, TX (US); Fang Lu, Billerica, MA (US)

(21) Appl. No.: 16/693,423

(22) Filed: Nov. 25, 2019

(51) Int. Cl. G06F 9/451; G09B 21/00

(52) U.S. Cl. CPC G06F 9/453; G09B 21/006

(57) ABSTRACT

Embodiments of the present invention provide computer-implemented methods, computer program products and systems. Embodiments of the present invention can identify display settings of a first computing device and a second computing device of a plurality of computing devices. Embodiments of the present invention can identify objects to be displayed by the first computing device and viewed on the second computing device. Embodiments of the present invention can then generate a mapping of the identified objects that do not match in appearance based on the identified display settings of the first computing device and the second computing device and dynamically modify the identified objects such that the identified objects match in appearance for both the first computing device and the second computing device.

### BACKGROUND

The present invention relates generally to the assistive visual tools, and more particularly to contextual based dynamic modification of content.

Assistive technology (AT) is assistive, adaptive, and rehabilitative devices typically refer to a technology group that helps users. Typically, visual assistive devices help users that may have visual impairments. Examples of assistive technology for visually impairment include screen readers, screen magnifiers, Braille embossers, desktop video magnifiers, and voice recorders.

Desktop video magnifiers and screen magnification software enable a user to view content displayed on a screen. In some instances, they enlarge texts and graphics on their computer screens for easier viewing.

### SUMMARY

Embodiments of the present invention provide computer-implemented methods, computer program products and systems. In one embodiment of the present invention, a computer-implemented method is provided comprising: identifying display settings of a first computing device and a second computing device of a plurality of computing devices; identifying objects to be displayed by the first computing device and viewed on the second computing device; generating a mapping of the identified objects that do not match in appearance based on the identified display settings of the first computing device and the second computing device; and dynamically modifying the identified objects such that the identified objects match in appearance for both the first computing device and the second computing device

### BRIEF DESCRIPTION OF THE DRAWINGS

FIG. 1, is a functional block diagram illustration a computing environment, in accordance with an embodiment of the present invention;

FIG. 2 is a flowchart depicting operational steps for dynamically adjusting display settings for computing devices, in accordance with an embodiment of the present invention; and

FIG. 3 depicts a block diagram of components of the computing systems of FIG. 1, in accordance with an embodiment of the present invention.

### DETAILED DESCRIPTION

Embodiments of the present invention recognize deficiencies of assistive visual technology systems. Specifically, embodiments of the present invention recognize that screen settings of users can differ. This can sometimes result in a difference in perception in content being displayed. For example, a presentation may display an object that, to the presenter (and the presenter's computer settings) appear to be blue and reference that object as being blue while a user viewing the presentation remotely (and having different display settings) may see that same object as appearing purple. As such, embodiments of the present invention provide solutions for the possible perception inconsistencies that result from different display settings. Specifically, embodiments of the present invention can dynamically adjust content presented prior to presentation of the content such that the presented content matches what a user viewing the presentation sees. For example, a user presenting content may references an object in the presentation as being yellow; however, based on display settings of a user viewing the presentation, may appear to be green. In this instances, embodiments of the present invention could alter the presenter's content to reference and describe the object from “yellow” to “green” prior to the user viewing the presentation.

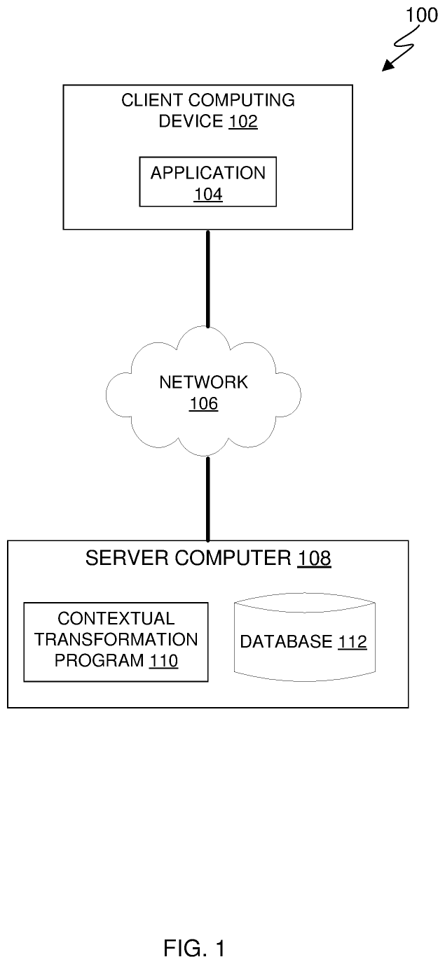

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

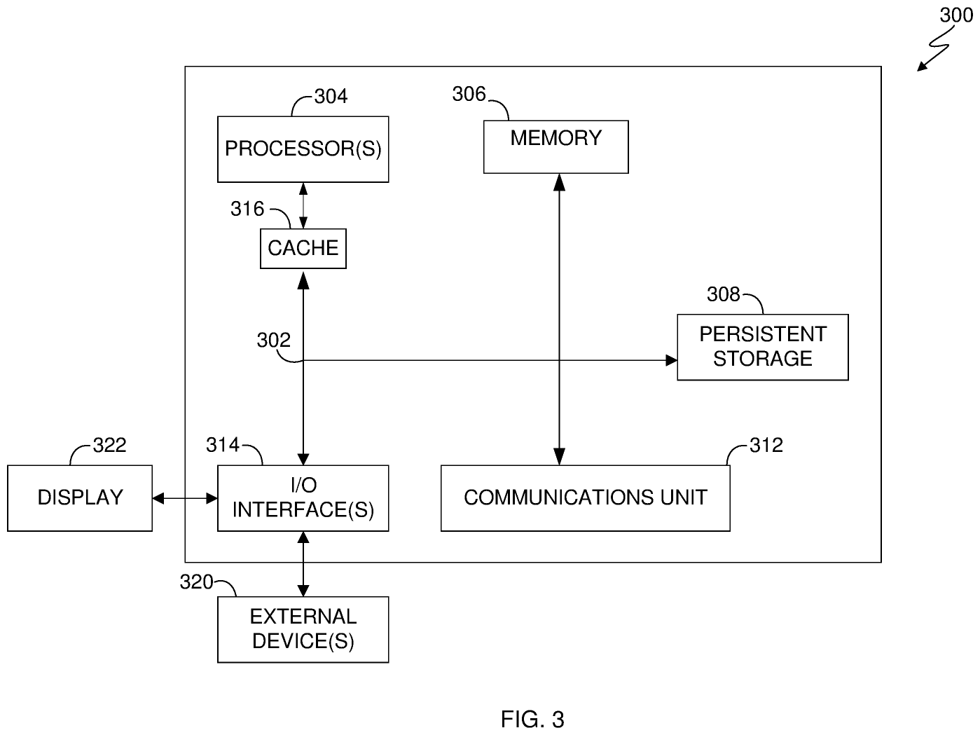

Computing environment 100 includes client computing device 102 and server computer 108, all interconnected over network 106. client computing device 102 and server computer 108 can be a standalone computer device, a management server, a webserver, a mobile computing device, or any other electronic device or computing system capable of receiving, sending, and processing data. In other embodiments, client computing device 102 and server computer 108 can represent a server computing system utilizing multiple computer as a server system, such as in a cloud computing environment. In another embodiment, client computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102 and server computer 108 each represent a computing system utilizing clustered computers and components (e.g., database server computers, application server computers, etc.) that act as a single pool of seamless resources when accessed within computing environment 100. In some embodiments, client computing device 102 and server computer 108 are a single device. Client computing device 102 and server computer 108 may include internal and external hardware components capable of executing machine-readable program instructions, as depicted and described in further detail with respect to FIG. 3.

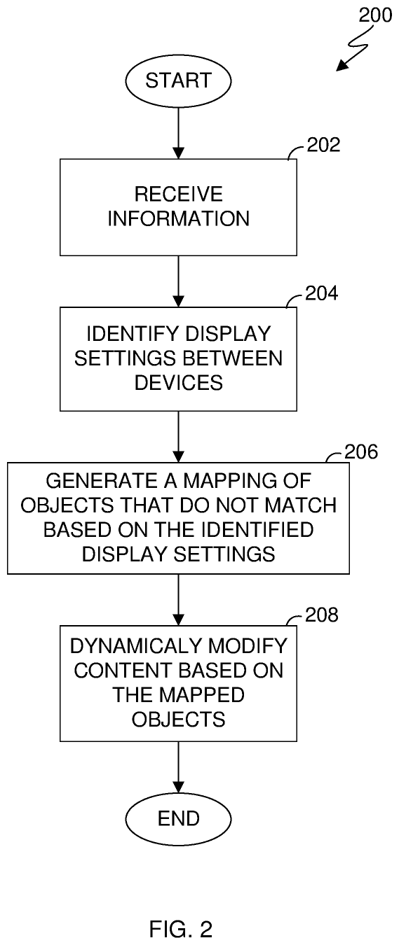

Client computing device 102 is a digital device associated with a user and includes application 104. Application 104 communicates with server computer 108 to access contextual transformation program 110 (e.g., using TCP/IP) to access user information. Application 104 can further communicate with contextual transformation program 110 to transmit instructions to dynamically adjust content presented prior to presentation of the content such that the presented content matches what a user viewing the presentation sees with regard to FIG. 2. In some embodiments, application 104 can transmit user information (e.g., text-based, audio-based, image based information, display setting information, etc.). In other embodiments, application 104 can transmit user preferences to contextual transformation program 110. In general, application 104 can be implemented using a browser and web portal or any program that can interface with or otherwise access contextual transformation program 110.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts contextual transformation program 110 and database 112. In this embodiment, database 112 functions as a repository for stored content. Database 112 can reside on a cloud infrastructure and stores user content. Content can include one or more media files containing any combination of text, image, audio and/or video. Content can also include one or more applications (e.g., programs, web interfaces, websites such as social media websites, etc.). In some embodiments, database 112 can function as a repository for one or more files containing user information such as display setting information, one or more media files, etc.

As used mentioned earlier, “user information” refers to information associated with a user and can be found in a user's profile, user preferences, display settings, device information, etc. User information can also refer to position information of the user (e.g., a position of a user with respect to a viewing screen). In this embodiment, database 112 is stored on server computer 108 however, database 112 can be stored on a combination of other computing devices (not shown) and/or one or more components of computing environment 100 (e.g., client computing device 102). In this embodiment, user information is obtained by contextual transformation program 110 with consent of the user via an opt-in/opt-out mechanism. In certain other embodiments, contextual transformation program 110 can transmit a notification to the user when user information is collected or otherwise being used.

In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108. In other embodiments, database 112 can be stored on other computing devices (not shown) or can be a combination of one or more other databases that has given permission access to contextual transformation program 110.

In this embodiment, contextual transformation program 110 resides on server computer 108. In other embodiments, contextual transformation program 110 can have an instance of the program (not shown) stored locally on client computer device 102. In yet other embodiments, communication prediction program can be stored on any number or computing devices (e.g., a smart device).

Contextual transformation program 110 dynamically adjust content presented prior to presentation of the content such that the presented content matches what a user viewing the presentation sees. In this embodiment, contextual transformation program 110 dynamically adjusts content presented prior to presentation of the content by identifying device information associated with a presenter device and a viewing device and modifying content based on the identified device information as discussed in greater detail with regard to FIG. 2.

A “presenter device”, as used herein refers to a computing device which acts as the computing device hosting, projecting, or otherwise sharing content. In this embodiment, content, is defined as one or more media files containing any combination of text, image, audio and/or video. For example, content can be present slides having a combination of text, image, audio, and video, a text-based file, media containing image, audio, and/or video.

Conversely, a viewing device, as used herein in refers to a computing device that displays content shared by the present device. In this embodiment, a viewing device can be a standalone computer device, a management server, a webserver, a mobile computing device, or any other electronic device or computing system capable of receiving, sending, and processing data. In some instances, a viewing device can be a projector device that projects shared content onto a screen.

For the purpose of this example, embodiments of the present invention utilize a single presenter device and viewing device; however it should be understood that that contextual transformation program 110 can dynamically adjust content presented prior to presentation of the content for multiple viewing devices. For example, contextual transformation program 110 can adjust content shared by the presenter device referencing an object as a “yellow” such that a first viewing device views the text referencing the object as “green” (as opposed to yellow) while adjusting the content from the presenter device being viewed on a second viewing device to show the text as “blue” (as opposed to yellow). Furthermore, a viewing device can switch or otherwise become a presenter device. For example, during a web conference meeting, the viewing device may be given permission to share content, effectively making the viewing device as the presenter device and the presenter device the viewing device.

In this embodiment, contextual transformation program 110 can first identify display settings of respective user devices (e.g., presenter device and one or more viewing devices) by transmitting a request to respective user computing devices for display settings. In this embodiment, contextual transformation program 110 can iteratively monitor viewing device settings at regular intervals. In other embodiments, the presenter device may transmit instructions for a schedule for contextual transformation program 110 to follow.

Examples of display settings can include having brightness settings, color settings, scale, layout, display resolution, graphic settings, signal resolution, refresh rate, bit depth, color format, color space, etc. Other examples of display settings can include system configurations for different operating systems. For example, high contrast color for a first viewing device showing a color as being a bright blue with a first operating system. Contextual transformation program 110 can also identify normal settings for a second viewing device showing a light blue for a second operating system while a high contrast setting for a third viewing device displaying purple.

Contextual transformation program 110 can then generate a mapping of objects to be displayed in each respective device, and modify content such that the presented content matches what a user viewing the presentation sees as discussed in greater detail with respect to FIG. 2. For example, a user presenting content on a presenter device may reference an object in the presentation as being yellow; however, based on display settings of a user viewing the presentation (e.g., on a viewing device), may appear to be green. In this instances, embodiments of the present invention could alter the presenter's content to reference and describe the object from “yellow” to “green” prior to the user viewing the presentation.

In some embodiments, contextual transformation program 110 can alter the display settings of the viewing device to match content being presented on the presenter device. For example, in an instance where the presenter device may reference an object in the presentation as being yellow, contextual transformation program 110 can identify that the viewing device settings are configured to show the same object as being green. Contextual transformation program 110 can then automatically change the display settings of the viewing device so that the user views the content shared from the presenter device as yellow.

In another instance, contextual transformation program 110 can alter content by altering the display settings of the viewing device by enabling or displaying certain modes of the viewing device. For example, contextual transformation program 110 can enable and display high contrast modes to enable the user to view content as shared and presented by the viewing device. In other embodiments, contextual transformation program 110 can alter the user display settings by enabling certain portions of the viewing device to display a high contrast mode. In yet other embodiments, contextual transformation program 110 can selectively alter user display settings based on applications being used by the viewing device to view content shared by the presenter device.

In yet another embodiment, contextual transformation program 110 can alter content by altering user audio of the viewing device based on the identified user settings and mapped objects. For example, a user using a viewing device has a high contrast mode setting and that blue icons appear to be an orange color in the viewing device. Contextual transformation program 110 can alter the user audio of the presenter device which could include audio describing an icon as “blue” to audio that audibly states “orange” to match the user's display settings.

In yet another embodiment, contextual transformation program 110 can alter content by altering user interfaces of the viewing device. For example, contextual transformation program 110 can identify user interface objects of a viewing device (e.g., one or more icons and/or selectable icons). Contextual transformation program 110 can then generate a mapping of the identified user interface objects and, in response to a presenter device mentioning one of the objects, contextual transformation program 110 can highlight the object. In another embodiment, contextual transformation program can generate a flashing graphic or symbol over the icon to denote the object being referenced by the presenter device.

FIG. 2 is a flowchart 200 depicting operational steps for dynamically adjusting display settings for computing devices, in accordance with an embodiment of the present invention.

In step 202, contextual transformation program 110 receives information. In this embodiment, contextual transformation program 110 receives information by transmitting a request to client computing device 102 for information. Information received by contextual transformation program 110 generally refers to user information that refers to information associated with a user and can be found in a user's profile, user preferences, display settings, device information, and position information of the user (e.g., a position of a user with respect to a viewing screen).

In some instances, a computing device (e.g., client computing device 102) can designate itself or another computing device as a presenter device. Contextual transformation program 110 can then classify other computing devices as viewing devices. Contextual transformation program 110 can also receive content to be displayed to one or more viewing devices. As mentioned above, content, refers to as one or more media files containing any combination of text, image, audio and/or video. For example, content can be present slides having a combination of text, image, audio, and video, a text-based file, media containing image, audio, and/or video.

In certain embodiments, contextual transformation program 110 can be given permission access by a user to access user information directly from client computing device 102 at regular, pre-defined intervals. In other embodiments, user information can be sent from client computing device 102 to contextual transformation program 110 at regular intervals.

In step 204, contextual transformation program 110 identifies display settings. In this embodiment, contextual transformation program 110 identifies display settings of respective user devices (e.g., presenter device and one or more viewing devices) by transmitting a request to respective user computing devices for display settings. Contextual transformation program 110 can then receive display settings of respective user devices via network 106. For example, contextual transformation program 110 can identifies display settings of a presenter device as having brightness settings, color settings, scale, layout, display resolution, graphic settings, signal resolution, refresh rate, bit depth, color format, color space, etc.

In step 206, contextual transformation program 110 generates a mapping of objects that do not match based on the identified display settings. In this embodiment, contextual transformation program 110 generates a mapping of objects in content (e.g., received in step 202) to be displayed on one or more viewing devices by identifying objects in received content. Contextual transformation program 110 identifies objects in content, identifies content (e.g., text, audio, image) describing the identified objects using a combination of object recognition and machine learning algorithms, identifies differences in appearance of the identified objects, and accordingly maps the identified objects as discussed in greater detail below.

Contextual transformation program 110 uses a combination of natural language processing techniques, machine learning algorithms, and artificial intelligence algorithms to identify text associated with the mapped objects. For example, content received by contextual transformation program can be a slide deck for a presentations that contains two slides. Contextual transformation program 110 can identify that there are three total objects in the received content (e.g., two objects on the first slide and one object on the second slide). Contextual transformation program 110 can then identify text associated with each object. For example, the first object can have text associated with it describing the first object as having a blue color.

Contextual transformation program 110 can then identify differences in how objects are displayed on the respective computing devices (e.g., differences between how objects are displayed on a presenter device and how objects are displayed or otherwise appear on a viewing device) based on the identified display settings. In this embodiment, contextual transformation program 110 can identify that objects appearing on respective computing devices do not match by simulating a display of each object using the respective computing device's display settings. For example, contextual transformation program 110 can identify that objects do not match based on display settings in instances where a presenter device references a color as blue (and associated color and pigment values depicting the color as blue) but, based on settings of a viewing device shows the same object and associated color and pigment values as orange).

In other embodiments, contextual transformation program 110 can compare the display settings and color values. In response to determining that the color values and display settings are not within an acceptable threshold value for color similarity, contextual transformation program 110 can determine that the object being displayed on the presenter device does not match the color being displayed of the viewing device. For example, contextual transformation program 110 can have a threshold value for color similarity based on a numerical percentage scale ranging from zero to one hundred. In this example, the threshold value for color similarity is 50%, that is, a color similarity percentage of 50% or greater establishes that the color values for a first computing device (e.g., the presenter device) and a second computing device (e.g., the viewing device) match. Conversely, a color similarity below 50% establishes that the color values for the first and the second computing device do not match. In other embodiments, the threshold value for color similarity can be configured to any desired value. In this embodiment, contextual transformation program 110 determines whether or not the threshold value for color similarity (e.g., 50%) is reached or exceeded. In response to determining that the threshold value for color similarity is reached or exceeding, contextual transformation program 110 identifies the object as matching (e.g., display appearance on both the first and the second computing device match text and/or audio describing the identified object). Contextual transformation program 110 can then map (e.g., add) each identified object failing to reach or exceed the threshold value for color similarity into a database (e.g., database 112).

In step 208, contextual transformation program 110 dynamically modifies content based on the mapped objects. In this embodiment, contextual transformation program 110 dynamically modifies content being shared by the presenter device prior to being presented to users viewing the content. In this embodiment, contextual transformation program 110 can dynamically modify objects by altering the content (e.g., a slide and accompanying text) just prior to that content (e.g., the slide) being displayed. In instances where the content is a slide deck presentation, contextual transformation program 110 can identify display settings of both the presenter and viewing device at either a regular interval time interval (e.g., every 30 seconds) or immediately prior to being displayed (e.g., identifying display settings of respective viewing devices). In this embodiment, contextual transformation program 110 can utilize a combination of artificial intelligence and machine learning algorithms to predict a time, based on context, just prior to content being displayed. Contextual transformation program 110 can then identify display settings of viewing devices and modify content at the predicted time. For example, contextual transformation program 110 can predict at a time 30 seconds into a presentation that the viewing device will switch from slide 1 to slide 2. Contextual transformation program 110 can then identify or otherwise verify display settings prior to the predicted time and modify the content (e.g., slide 2) so that the content (e.g., text associated with an object) is referenced and displayed correctly on the viewing device (e.g., so that the object is described in a color that the user's viewing device shows the object).

In another embodiment, contextual transformation program 110 can modify affected text associated with the mapped objects in the content and further transmit the modified content to the viewing device . For example, contextual transformation program 110 can modify an entire content (e.g., an entire presentation) and transmit the modified content to the viewing device as a new presentation. In yet another embodiment, in response to a request from either the viewing device or the presenter device, contextual transformation program 110 can modify a presenter device's display settings to match the viewing device display settings so that a user of the presenter device can see an object as seen by the user of the viewing device.

FIG. 3 depicts a block diagram of components of computing systems within computing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 300 includes communications fabric 302, which provides communications between cache 316, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a crossbar switch.

Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Contextual transformation program 110 (not shown) may be stored in persistent storage 308 and in memory 306 for execution by one or more of the respective computer processors 304 via cache 316. In an embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. Contextual transformation program 110 may be downloaded to persistent storage 308 through communications unit 310.

I/O interface(s) 312 allows for input and output of data with other devices that may be connected to client computing device and/or server computer 108. For example, I/O interface 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention, e.g., contextual transformation program 110, can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
identifying display settings of a first computing device and a second computing device of a plurality of computing devices;
identifying objects to be displayed by the first computing device and viewed on the second computing device;
generating a mapping of the identified objects that do not match in appearance based on the identified display settings of the first computing device and the second computing device; and
dynamically modifying the identified objects such that the identified objects match in appearance for both the first computing device and the second computing device.

2. The computer-implemented method of claim 1, wherein generating a mapping of the identified objects that do not match in appearance comprises:
comparing the identified display settings of the first computing device and the second computing device;
identifying differences between the identified display settings of the first computing device and the second computing device for each identified object;
determining whether each of the identified differences for each respective identified object reaches or exceeds a threshold value for color similarity; and
in response to determining that an identified object does not reach or exceed the threshold value for color similarity, adding the identified object to a database.

3. The computer-implemented method of claim 1, wherein dynamically modifying the identified objects such that the identified objects match in appearance for both the first computing device and the second computing device comprises:
modifying content associated with each identified object of the identified objects prior to each identified object being displayed on the second computing device.

4. The computer-implemented method of claim 1, wherein dynamically modifying the identified objects such that the identified objects match in appearance for both the first computing device and the second computing device comprises:
predicting a time in which to modify content associated with each identified object of the identified objects prior to each identified object being displayed on the second computing device.

5. The computer-implemented method of claim 1, wherein dynamically modifying the identified objects such that the identified objects match in appearance for both the first computing device and the second computing device comprises modifying a user interface of the second computing device to display each identified object in a manner that matches display values of the first computing device.

6. The computer-implemented method of claim 1, wherein dynamically modifying the identified objects such that the identified objects match in appearance for both the first computing device and the second computing device comprises modifying audio associated with each identified object such that the modified audio matches a text description of the identified object, according to the identified display settings of the second computing device.

7. The computer-implemented method of claim 1, wherein dynamically modifying the identified objects such that the identified objects match in appearance for both the first computing device and the second computing device comprises altering one or more display modes of the first computing device and the second computing device.

8. A computer program product comprising:
one or more computer readable storage media and program instructions stored on the one or more computer readable storage media, the program instructions comprising:
program instructions to identify display settings of a first computing device and a second computing device of a plurality of computing devices;
program instructions to identify objects to be displayed by the first computing device and viewed on the second computing device;
program instructions to generate a mapping of the identified objects that do not match in appearance based on the identified display settings of the first computing device and the second computing device; and
program instructions to dynamically modify the identified objects such that the identified objects match in appearance for both the first computing device and the second computing device.

9. The computer program product of claim 8, wherein the program instructions to generate a mapping of the identified objects that do not match in appearance comprise:
program instructions to compare the identified display settings of the first computing device and the second computing device;
program instructions to identify differences between the identified display settings of the first computing device and the second computing device for each identified object;
program instructions to determine whether each of the identified differences for each respective identified object reaches or exceeds a threshold value for color similarity; and
program instructions to, in response to determining that an identified object does not reach or exceed the threshold value for color similarity, add the identified object to a database.

10. The computer program product of claim 8, wherein the program instructions to dynamically modify the identified objects such that the identified objects match in appearance for both the first computing device and the second computing device comprise:
program instructions to modify content associated with each identified object of the identified objects prior to each identified object being displayed on the second computing device.

11. The computer program product of claim 8, wherein the program instructions to dynamically modify the identified objects such that the identified objects match in appearance for both the first computing device and the second computing device comprise:
program instructions to predict a time in which to modify content associated with each identified object of the identified objects prior to each identified object being displayed on the second computing device.

12. The computer program product of claim 8, wherein the program instructions to dynamically modify the identified objects such that the identified objects match in appearance for both the first computing device and the second computing device comprise program instructions to modify a user interface of the second computing device to display each identified object in a manner that matches display values of the first computing device.

13. The computer program product of claim 8, wherein the program instructions to dynamically modify the identified objects such that the identified objects match in appearance for both the first computing device and the second computing device comprise program instructions to modify audio associated with each identified object such that the modified audio matches a text description of the identified object, according to the identified display settings of the second computing device.

14. The computer program product of claim 8, wherein the program instructions to dynamically modify the identified objects such that the identified objects match in appearance for both the first computing device and the second computing device comprise program instructions to alter one or more display modes of the first computing device and the second computing device.

15. A computer system comprising:
one or more computer processors;
one or more computer readable storage media; and
program instructions stored on the one or more computer readable storage media for execution by at least one of the one or more computer processors, the program instructions comprising:
program instructions to identify display settings of a first computing device and a second computing device of a plurality of computing devices;
program instructions to identify objects to be displayed by the first computing device and viewed on the second computing device;
program instructions to generate a mapping of the identified objects that do not match in appearance based on the identified display settings of the first computing device and the second computing device; and
program instructions to dynamically modify the identified objects such that the identified objects match in appearance for both the first computing device and the second computing device.

16. The computer system of claim 15, wherein the program instructions to generate a mapping of the identified objects that do not match in appearance comprise:
program instructions to compare the identified display settings of the first computing device and the second computing device;
program instructions to identify differences between the identified display settings of the first computing device and the second computing device for each identified object;
program instructions to determine whether each of the identified differences for each respective identified object reaches or exceeds a threshold value for color similarity; and
program instructions to, in response to determining that an identified object does not reach or exceed the threshold value for color similarity, add the identified object to a database.

17. The computer system of claim 15, wherein the program instructions to dynamically modify the identified objects such that the identified objects match in appearance for both the first computing device and the second computing device comprise:
program instructions to modify content associated with each identified object of the identified objects prior to each identified object being displayed on the second computing device.

18. The computer system of claim 15, wherein the program instructions to dynamically modify the identified objects such that the identified objects match in appearance for both the first computing device and the second computing device comprise:
program instructions to predict a time in which to modify content associated with each identified object of the identified objects prior to each identified object being displayed on the second computing device.

19. The computer system of claim 15, wherein the program instructions to dynamically modify the identified objects such that the identified objects match in appearance for both the first computing device and the second computing device comprise program instructions to modify a user interface of the second computing device to display each identified object in a manner that matches display values of the first computing device.

20. The computer system of claim 15, wherein the program instructions to dynamically modify the identified objects such that the identified objects match in appearance for both the first computing device and the second computing device comprise program instructions to modify audio associated with each identified object such that the modified audio matches a text description of the identified object, according to the identified display settings of the second computing device.
